(19) United States
(12) Patent Application Publication
(10) Pub. No.: US 2018/0123814 A1
(43) Pub. Date: May 3, 2018

(54) LIVE MEETINGS FOR CHANNELS IN A TEAM COLLABORATION TOOL

(71) Applicant: Microsoft Technology Licensing, LLC, Redmond, WA (US)

(72) Inventors: Eric R. Sexauer, Woodinville, WA (US); Ewin Davis Kannuthottiyil, Prague (CZ); Kevin Morrison, Boston, MA (US)

(21) Appl. No.: 15/483,460

(22) Filed: Apr. 10, 2017

Related U.S. Application Data
(60) Provisional application No. 62/416,697, filed on Nov. 2, 2016.

(51) Int. Cl. H04L 12/18

(52) U.S. Cl. CPC H04L 12/1818; H04L 12/1831; H04L 12/185; H04L 12/1881; H04L 12/1822

(57) ABSTRACT

A team collaboration tool can create a new meeting object, wherein the new meeting object is associated with a thread. The new meeting object can be a scheduled meeting object, a live meeting object, or a meeting ended object. In response to receiving a request for a scheduled meeting object for a meeting, a system can determine at least a start time and a thread identifier for the scheduled meeting object, create the scheduled meeting object with at least the start time; and store, at a persistent team collaboration storage, the scheduled meeting object associated with the thread identifier. At the start time of the scheduled meeting object, the system can create the live meeting object; and after the meeting ends, the system can create the meeting ended object and store the meeting ended object associated with the thread identifier.

### CROSS-REFERENCE TO RELATED APPLICATION

This application claims the benefit of U.S. Provisional Patent Application Ser. No. 62/416,697, filed Nov. 2, 2016.

### BACKGROUND

Most meeting solutions are based in email or are stand-alone meeting applications. A user can join the meeting after receiving an invitation to join (e.g., a link to the coordinates for the meeting). Users have increasingly turned to team collaboration tools to help them communicate among groups of users. Many team collaboration tools allow users to communicate with various groups of users with regards to various topics and provide private and group conversation threads. However, meetings tend to be available to only those with an invitation to the meeting and separate from team collaboration tools.

### BRIEF SUMMARY

Live meetings can be incorporated in team collaboration tools through the inclusion of meeting objects that can be stored associated with a thread. The thread may be within a collaboration channel. The described meeting objects enable a user to openly communicate about a meeting to other members of the team—even those not specifically invited to the meeting—and can be used to preserve information related to the meeting.

A team collaboration tool can support meeting objects such that users can schedule a live meeting into a channel or, at least, as part of a thread between a group of users. In response to receiving a request for a scheduled meeting object, a system supporting the team collaboration tool can create the scheduled meeting object and store the scheduled meeting object associated with a thread. When the meeting time starts, the system can create a live meeting object and when the meeting ends, the system can create a meeting ended object, all associated with (and anchored to) the thread.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in which various embodiments of the invention may be practiced.

FIG. 2A illustrates example processes for providing meeting objects associated with a thread within a collaboration channel.

FIG. 2B illustrates a sequence diagram for live meetings for channels in a team collaboration tool.

FIGS. 3A-3D, 4A-4C, and 5A-5C show screen shots of a user interface illustrating example scenarios for providing a meeting object associated with a thread within a collaboration channel.

FIG. 6 illustrates components of a computing device that may be used in certain implementations described herein.

FIG. 7 illustrates components of a computing system that may be used to implement certain methods and services described herein.

### DETAILED DESCRIPTION

Live meetings can be incorporated in team collaboration tools through the inclusion of meeting objects that can be stored associated with, and anchored to, a thread (such that the meeting object can be considered to be within the thread). The thread may be within a collaboration channel. The described meeting objects enable a user to openly communicate about a meeting to other members of the team—even those not specifically invited to the meeting—and can be used to preserve information related to the meeting.

Team collaboration tools can support a variety of communications and content including, but not limited to, one or more of video, audio, text, file attachments, instant messages (e.g., exchanges between two—and sometimes more—people), chat messages (e.g., messaging within a chat room or other virtual meeting area), email, calendar entries, meeting entries, and the like. Examples of team collaboration tools include MICROSOFT SKYPE TEAMS and SLACK. Other applications that include at least some meetings, collaboration, and messaging capabilities include FACEBOOK (and FACEBOOK MESSENGER), GOTOMEETING, and JOIN.ME.

Different types of team collaboration tools have been developed to allow users to communicate over a network and work in virtual teams. Within electronic chat application types of team collaboration tools, users can conduct conversations between one another, or between a group of people. Groups of users working together may be referred to as “teams”. A team may be project-based (e.g., based on a project that the members are collaborating on), location-based (e.g., representing a group of people working in a same building, city, region, etc.), organization-based (e.g., according to an organizational hierarchy), other arrangement, or combination thereof.

Team collaboration tools may be implemented in multi-tenant environments. In multi-tenant and single tenant instances of team collaboration software, one or more teams can be provided (each with its own identifier). Administrator users can define teams for their instance of the team collaboration tool. For example, a team may include users who are employees in a specific department of a company. Users who are assigned to (or join) a team can access content and collaborate with team members. Within a team, a sub-team or grouping, also known as a “collaboration channel”, can be provided to organize communications between a subset of users and/or communications on a particular topic or project.

A collaboration channel refers to the mode or means for information to flow within an organization or group of users. A channel can be labeled with anything that can semantically mean something for a group of people. Collaboration channels provide a common location (and method) to share content and conduct conversations. In the described team collaboration tools, a collaboration channel is a persistent chat communication around a topic. This allows for a user to view the past history of content shared within the channel. In some cases, each channel can have online storage associated with it. Collaboration channels help users to route their questions and comments to the appropriate audience, and can be used to authorize users to specific kinds of information. In many team collaboration tools content shared through a collaboration channel is managed in the form of a threaded discussion. Each collaboration channel can engage in a certain type or multiple types of discussions. However, collaboration channels may be dynamic, and new collaboration channels do not need to be created for each new and additional topic that a user of the collaboration channel wants to discuss.

An example collaboration channel is a chat room. Users may be able to enter the collaboration channel based on access permissions. Within collaboration channels, there may be two levels of security: open and restricted. Open collaboration channels are open to all users of a team. Restricted collaboration channels typically have membership requirements, and are open only to those users of a team who meet these requirements. A user can join a collaboration channel either by invite from the collaboration channel creator, or by requesting for access. However, collaboration channels are generally open to users of a respective team by default, and users of the team can join or leave the respective collaboration channels freely. After entering a collaboration channel, a user can view the content and conversations shared by other users and can share their own content.

Senders and recipients of messages sent within collaboration channels may frequently exchange numerous messages on the same topic, replying several times to one another in the course of a discussion. This sequence of electronic messages is sometimes referred to as a “conversation” or a “thread” and may be visually grouped for a user so that the user can see messages with their replies. It should be understood that a thread does not require a collaboration channel or a team and that the described methods can be applied to team collaboration tools that do not specify “teams” or “collaboration channels”.

Messages within the collaboration channel may be threaded or unthreaded. Collaboration channels may contain multiple threads. Threaded messages are linked by conversation. Unthreaded messages may be displayed in chronological order regardless of what, if any, message the messages are responding to. Additionally, all threaded or unthreaded content may persist so that it remains in existence even when the line of communication is expanded, or there is no user in the collaboration channel. The content in a collaboration channel can remain in the collaboration channel for a period of time after the communication occurred, including being retained and/or archived indefinitely.

In the described team collaboration tools, meeting objects can be associated with and stored persistently as part of a thread (e.g., be “anchored” to a thread). The meeting objects can reside as a chat object inside a threaded history. A chat object refers to the data structure or instance of a message in a conversation (and can be referenced by an identifier). Timestamps can be added and associated with a chat object. Meetings have a lifecycle—before the meeting starts, during the meeting, and after the meeting ends. The life cycle of a meeting is reflected in the meeting objects provided for team collaboration tools. Three meeting objects described in detail herein include a scheduled meeting object, a live meeting object, and an end meeting object.

A scheduled meeting object can contain details about the meeting similar to those stored for calendar applications. For example, a scheduled meeting object can contain start time, end time, date, subject, invitees. In addition to the general meeting information, a scheduled meeting object

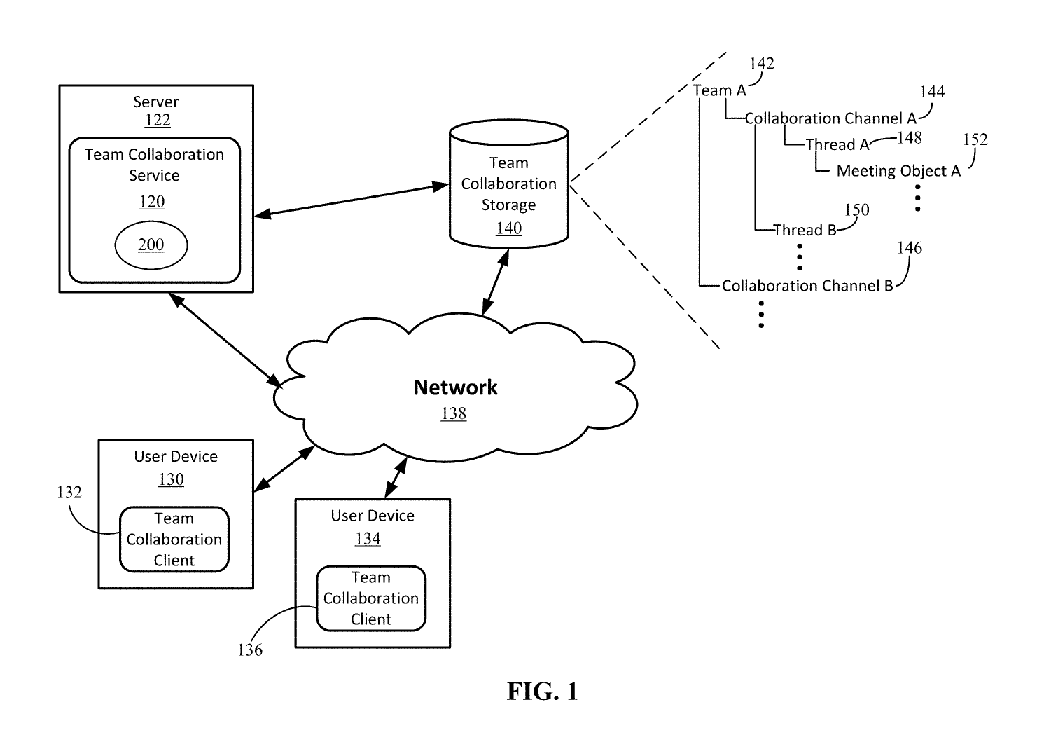

FIG. 1 illustrates an example operating environment for providing live meetings for channels in team collaboration tools. A team collaboration tool may include components that are local (at the user's device) and components that are residing on a server. For example, referring to FIG. 1, an operating environment can include a server 122 hosting a team collaboration service 120 that supports team collaboration clients (e.g., 132, 136) running on corresponding ones of a plurality of user devices (e.g., user device 130 and user device 134). User device(s) 130, 134 can communicate with server 122 and each other via network 138.

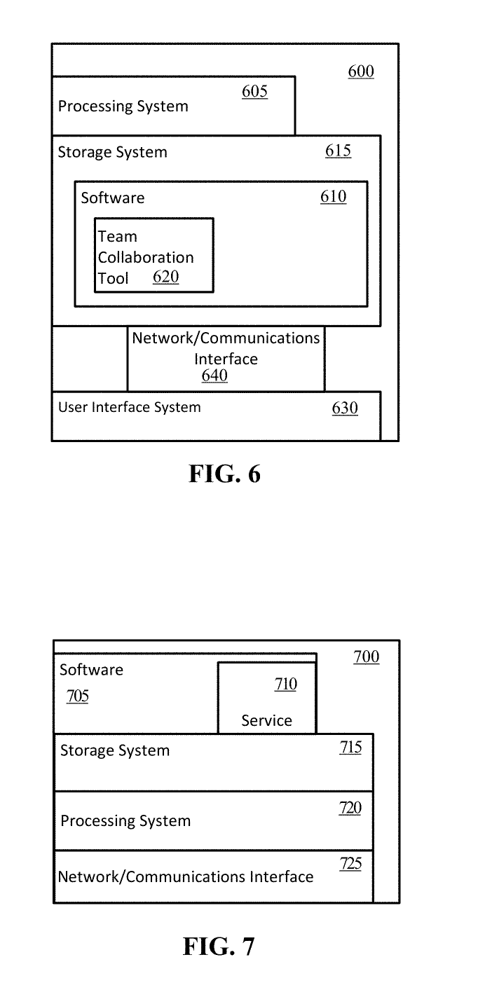

Server 122 may be embodied as described with respect to computing system 700 as shown in FIG. 7 and even, in whole or in part, by computing system 600 as described with respect to FIG. 6. Server 122 also includes, or communicates over network 138 (or other network) with, team collaboration storage 140 to manage stored content.

User devices 130, 134 may each be embodied as described with respect to computing system 600 as described with respect to FIG. 6. For example, user device 130 may be a computing device such as, but not limited to, a personal computer, a tablet computer, a reader, a mobile device, a personal digital assistant, a wearable computer, a smartphone, a laptop computer (notebook or netbook), a gaming device or console, a desktop computer, a smart television, and the like. Similarly, user device 134 (and any other user devices executing a team collaboration client) may be a computing device such as, but not limited to, a personal computer, a tablet computer, a reader, a mobile device, a personal digital assistant, a wearable computer, a smartphone, a laptop computer (notebook or netbook), a gaming device or console, a desktop computer, a smart television, and the like. Team collaboration clients (132, 136) may be implemented as a web-based tool and/or a local client.

Network 138 can include, but is not limited to, a cellular network, a satellite network, the Internet, a local area network (LAN), a wide area network (WAN), a WiFi network, an ad hoc network, or a combination thereof. The network 138 may include one or more connected networks (e.g., a multi-network environment) including public networks, such as the Internet, and/or private networks such as a secure enterprise private network. Access to the network 138 may be provided via wired and/or wireless means as will be understood by those skilled in the art. As will also be appreciated by those skilled in the art, communication networks can take several different forms and can use several different communication protocols.

Team collaboration storage 140 stores the team collaboration tool data in a structured format. The data structures may be in graph, table, or other suitable structured format. The team collaboration storage 140 may store data, including, at least, the history (e.g., chat objects) within a collaboration channel. Meeting objects are stored associated with (and anchored to) a thread in the team collaboration storage 140. For example, upon creation, a meeting object is stored in the team collaboration storage 140 associated with a thread. The thread may be stored associated with a collaboration channel and the collaboration channel may be stored associated with a team.

As an illustrative example, Team A 142 may include Collaboration Channel A 144 and Collaboration Channel B 146, as well as additional collaboration channels (not shown). Threads of conversations within a collaboration channel can be stored associated with that collaboration channel. For example, Thread A 148 and Thread B 150, as well as additional threads (not shown), are stored associated with Collaboration Channel A 144. In this manner, Thread A 148 and Thread B 150 are connected to Collaboration Channel A 144, which is connected to Team A 142 in the data structure stored in the team collaboration storage 140. Like other chat objects in a thread, the described meeting objects can be stored associated with a particular thread. For example, Thread A 148 may include Meeting Object A 152 as well as additional meeting objects (not shown).

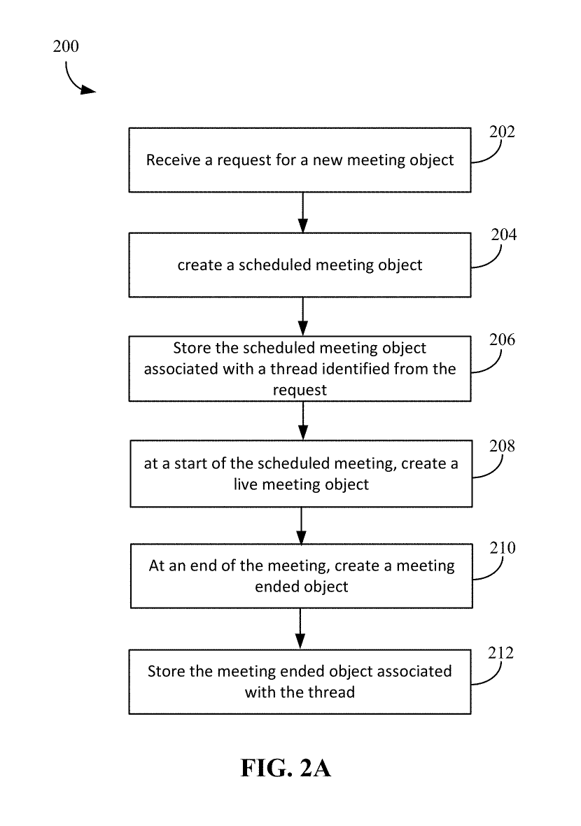

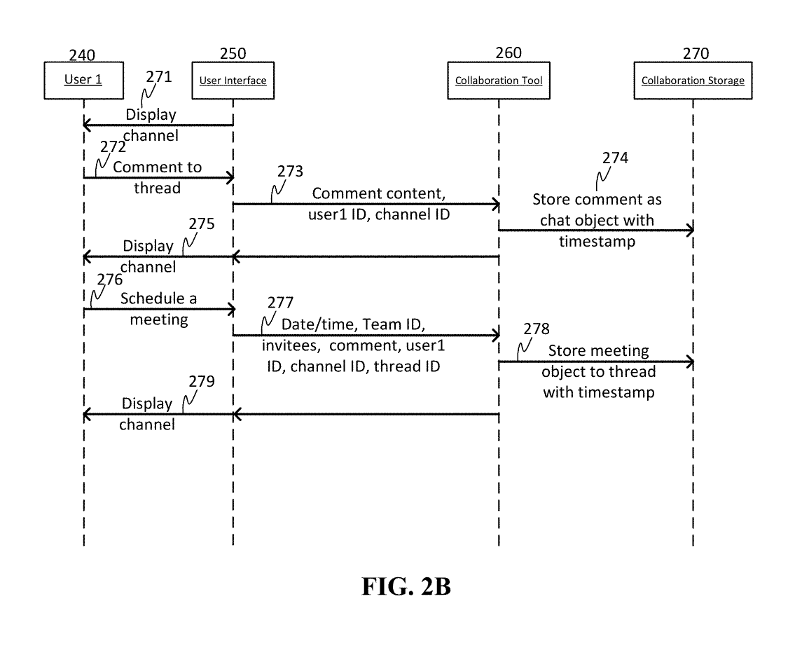

FIG. 2A illustrates example processes for providing meeting objects associated with a thread within a collaboration channel. Referring to FIG. 1 and FIG. 2A, the team collaboration service 120 can perform processes 200 and manage the team collaboration storage 140. For example, the team collaboration service can receive, from a team collaboration client, a request for a new meeting object (202). A meeting object may be considered “new” if it was not previously stored in the team collaboration storage 140.

The request may be from a user of a team collaboration tool (e.g. via team collaboration client 132, 136) on a user device (e.g. user device 130, 134). In some cases, a user interface of a team collaboration tool may be accessible through a web browser executing on a user device. The request may include certain identifiers in order to anchor the meeting object to an appropriate thread. For example, the request may include one or more of a user identifier, a team identifier, a channel identifier, and a thread identifier. The identifiers may be determined via context and automatically populated into a new meeting object (and/or used to appropriately map the meeting object). Alternatively, or in addition, a user of a team collaboration tool (e.g. team collaboration client 132, 136) may manually input parameters into input fields of a new meeting item form for populating the meeting object.

In response to receiving the request (202), the team collaboration service 120 may create the scheduled meeting object (204). The scheduled meeting object may include one or more parameters such as a start time of the meeting, an end time of the meeting, attendees of the meeting, details of the meeting, and an address to join the meeting. These parameters may be input by a user when creating the new meeting (and provided to the service along with the request from the team collaboration client 132, 136).

The scheduled meeting object may include functionality that allows a user to modify the parameters of the scheduled meeting object at a time after the scheduled meeting object is created. For example, the team collaboration client can provide a graphical interface for modifying the scheduled meeting object and send requests to the service to update the information associated with the previously requested meeting object.

The scheduled meeting object can then be stored associated with the thread (206). The thread association of the scheduled meeting object may be determined by using the identifiers (e.g., team identifier, channel identifier, and thread identifier) in the request to map the location of the scheduled meeting object within the team collaboration storage 140.

Additionally, at a start of a meeting, the team collaboration service 120 may create a live meeting object (208). The team collaboration service 120 may determine the start of the meeting based on a start time stored as part of the scheduled meeting object. In some cases, the scheduled meeting object transitions to the live meeting object. In some cases, the live meeting object as stored associated with the thread at a location in the thread corresponding to the timestamp of the start of the meeting. In some cases, a representation of the scheduled meeting object is replaced with or modified to include the graphical elements of the live meeting object. The live meeting object may also include functionality that allows the user to view the attendees of the scheduled meeting object, as well as give the user the ability to join a live instance of the meeting using an audio or video feed that displays in the user interface of a team collaboration tool. The live meeting object inherits, at least, the identifiers of the scheduled meeting object.

The live meeting object can be stored associated with the thread similarly to the scheduled meeting object. During the lifetime of the live meeting, additional conversations can take place and be anchored to the same thread under the meeting object and/or in reply to other conversations taking place in the channel. In addition, the display of the scheduled meeting object can transform to the live meeting object, providing command icons to join the meeting, indicating attendees, and other visual notifications. The team collaboration client can notify members of the team that there is a live meeting (even those members not specifically invited to join the meeting) in a variety of ways. In some cases, a live meeting notification (which may be a function in the live meeting object) can be displayed to team members. The live meeting notification may be shown in a quick view calendar (which can include a mechanism for users to join the meeting). In some cases, an icon can show up on the channel display to show that there is a live meeting.

At the end of the meeting, which may be identified by all attendees leaving the meeting, by the organizer ending the meeting, or by some other action, the team collaboration service 120 may create a meeting ended object (210). The meeting ended object inherits, at least, the identifiers of the scheduled meeting object, and any data generated during the instance of a live meeting object. For example, an audio or video feed displayed during the instance of the live meeting may be recorded and stored in the live meeting object. In another example, the meeting ended object may contain data of the meeting that includes the participants, length of time, description, topic of discussion, or the like.

The meeting ended object can then be stored associated with the thread (212). The thread association of the meeting ended object may be determined by using the identifiers (e.g., team identifier, channel identifier, and thread identifier) in the request of the scheduled meeting object to map the location of the scheduled meeting object within the team collaboration storage 140.

In some implementations, the meeting objects (i.e., scheduled meeting object, live meeting object, and meeting ended object) may be created and stored by the team collaboration service 120 as one complete object. In other cases, the team collaboration service 120 may create and store each type of meeting object as each of their own separate individual objects.

FIG. 2B illustrates a sequence diagram for live meetings for channels in a team collaboration tool. In the illustrative scenario of a sequence of actions for a team collaboration tool incorporating live meetings into a channel, a user 240, user interface 250, collaboration tool 260, and collaboration storage 270 are shown. The user is representative of one user, but as described with respect to FIG. 1, there are a plurality of users and corresponding user devices and updates to a thread in a channel would be promulgated for display across all the users' devices that are members of the team and/or channel. Accordingly, a channel (271) can be displayed to a user via a user interface 250 to the collaboration tool 260. Although the collaboration tool 260 is shown as a single entity, the tool 260 may be implemented across multiple devices/systems such as the server and user device shown in FIG. 1, and more or less functionality for the team collaboration tool can be found at (and executed by) the user's device. A user 240 may comment (272) on a thread via the user interface 250.

The comment content and context such as user identifier and channel identifier (273) can be used by the collaboration tool 260 to store (274) the comment as a chat object with appropriate timestamp in the collaboration storage 270. The chat object and timestamp can be reflected in the display of the channel (275) in the user interface 250. While in the channel displayed at the user interface 250, the user 240 may desire to schedule a meeting (276). The meeting information (277) of date and time and context such as team identifier, user identifier, channel identifier, thread identifier, any comments, and any invitees can be used by the collaboration tool 260 to store (278) a meeting object with the meeting information associated with the thread in the collaboration storage 270. The meeting object, for example, can be anchored to the thread with the chat object previously entered by the user 240. The meeting object can be reflected in the display of the channel (279).

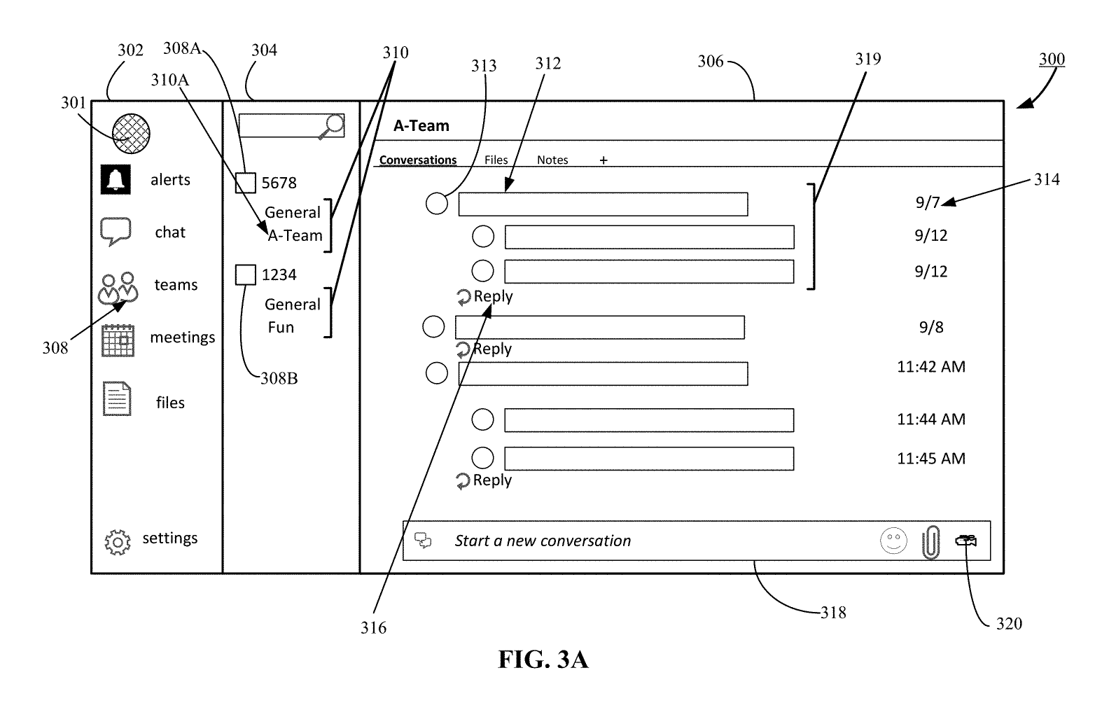

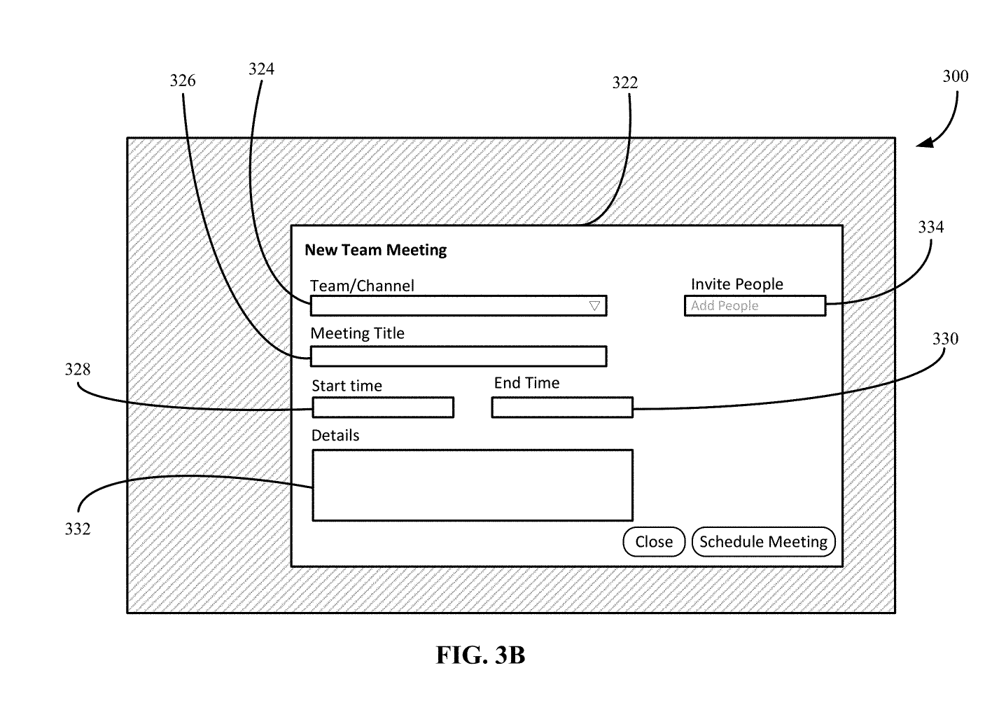

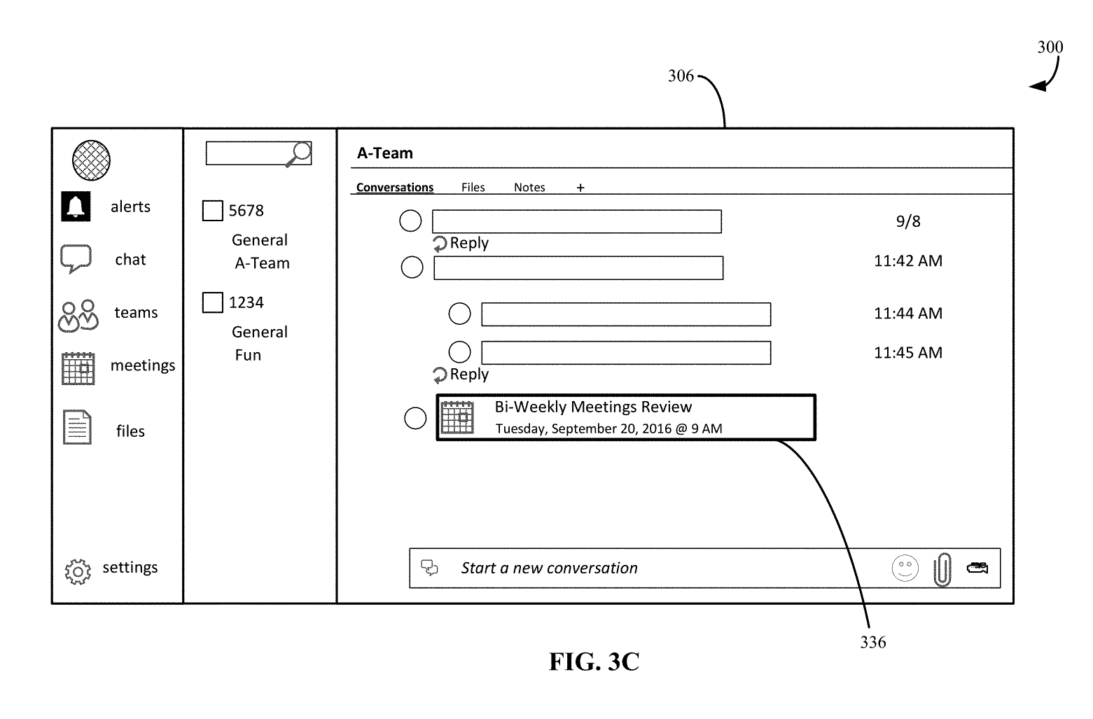

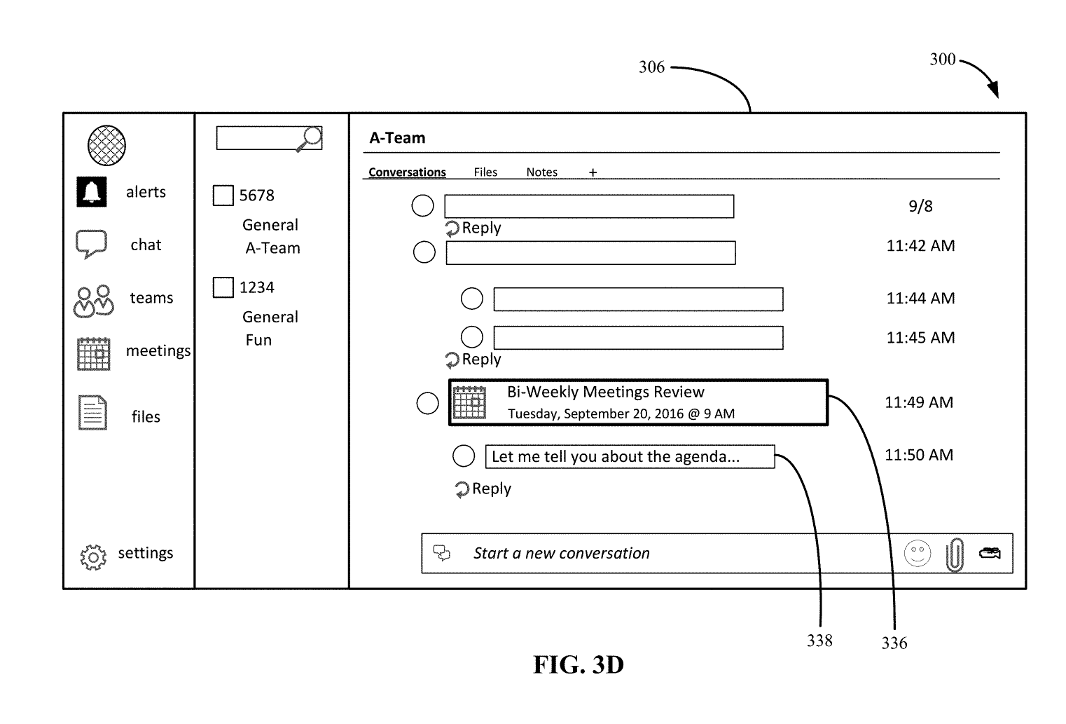

FIGS. 3A-3D, 4A-4C, and 5A-5C show screen shots of a user interface illustrating example scenarios for providing a meeting object associated with a thread within a collaboration channel. It should be noted that the graphical user interfaces are presented for illustrative purposes only and are not intended to be limiting in design; many other configurations of a team collaboration tool user interface and user selection of a meeting object are envisioned. FIGS. 3A-3D illustrate an example scenario in which a meeting object, specifically a scheduled meeting object, is created and displayed in a team collaboration tool user interface using the techniques described above.

FIG. 3A shows an example team collaboration tool user interface depicting a collaboration channel. In the exemplary user interface, a team collaboration tool user interface window (“user interface window”) 300 for a user (e.g., who may be identified by an image or icon 301) contains a left rail menu 302, an extended menu 304, and a group communication feed 306. The left rail menu 302 may contain various icons or tabs that a user may select. Additionally, notifications or indications may be displayed in the left rail menu 302 to notify the user of any tasks, meetings, or other activity or changes. In FIG. 3A, the extended menu 304 shows further information about teams 308. For example, the extended menu 304 shows two teams: team “5678” 308A and team “1234” 308B and their available collaboration channels 310. In the illustrative example, the group communication feed 306 is displaying the A-Team channel 310A for team “5678” 308A.

The group communication feed 306 allows users to collaborate and communicate while retaining history of the conversations. The system creates and displays a chat object 312 with user identification icon 313 and timestamp 314, for example as described with respect to FIG. 2B. Team members can reply to an existing comment (e.g., via reply field 316) to anchor a comment to the existing comment or start a new comment (e.g., via message entry field 318). The original comment and replies form a thread 319; and, according to some implementations, multiple threads can be in a channel 310. Users can also address specific users within the collaboration channel with a marker (e.g., “A”). The group communication feed 306 may display the messages of each user (e.g., chat object 312), along with the user identification icon 313 identifying the person who provided the content.

Other functionality may be included in the user interface window 300. For example, in this illustration, certain content may be organized and accessed via tabs such as a current available conversations tab, a files tab, and a notes tab. The tabs may allow a user to attach certain content into specific tabs to further categorize communication within a collaboration channel.

According to various implementations described herein, meetings can be established as part of a thread within a collaboration channel. The meeting object can be created by the team collaboration service as described above with respect to FIGS. 2A and 2B.

To create a scheduled meeting object, the user may select a new meeting icon command 320. The command 320 may be available near a reply field 316 and/or the message entry field 318. The command 320 may be available from menus, including the left rail menu 302. In some cases, the command may be initiated via verbal command or even via other input mechanisms (e.g., natural user interface, gestures, etc.).

Upon requesting to create a scheduled meeting object (e.g., by selecting the new meeting icon command 320), a new team meeting entry form interface 322 can be surfaced such as shown in FIG. 3B. The new meeting entry form interface 322 may include a variety of input fields allowing the user to input parameters of the meeting. The input fields may include, for example, a team/channel input field 324, a meeting title input field 326, a start time input field 328, an end time input field 330, a details input field 332, and an attendee input field 334. Of course, fewer or more fields may be provided.

The organizing user can input one or more of the parameters when scheduling the meeting and modify the parameters of the scheduled meeting object at a time after the scheduled meeting object is created.

The team/channel input field 324 may allow the user to indicate a team or a collaboration channel in which the meeting takes place. The meeting title input field 326 may allow the user to input a meeting title. The start time input field 328 may allow the user to input a start time of the meeting. The end time input field 330 may allow the user to input an end time of the meeting. The details input field 332 may allow the user to input any details about the meeting. The attendee input field 334 may allow the user to input attendees of the meeting. Attachments and other inputs may be possible.

The team collaboration tool (local and/or at server) can obtain context—through active or passive action by the user. The context can include one or more of a user identifier (e.g., user corresponding to image or icon 301), a team identifier (e.g., team “5678” 308A), a channel identifier (e.g., A-team channel 310A), and a thread identifier (e.g., thread 319 or new conversation thread). The context may be used by the team collaboration service to automatically populate certain parameters of a scheduled meeting object and/or store the scheduled meeting object associated with the appropriate thread. In some cases, the team collaboration client can auto-populate the form based on context of the application state (e.g., which channel was being displayed in the group communication feed 306 and which thread 319, if any, is the user interacting with).

In the example scenario, the user selected the new meeting command 320 available at the new message entry field 318, such that a new thread would be established for the meeting object (and other chat objects could be anchored to this new thread). The team collaboration tool can create the new scheduled meeting object and a scheduled meeting object 336 can be displayed in the group communication feed 306 of the user interface window 300 as illustrated in FIG. 3C. The scheduled meeting object 336 is stored associated with a thread so that it may persist throughout the history of the collaboration channel.

The scheduled meeting object 336 can be part of a new thread as shown in FIG. 3D. Any user of the collaboration channel can enter messages and other content items such that chat objects 338 can be anchored to the thread with the scheduled meeting object 336. The scheduled meeting object and the chat object persist/remain in the collaboration channel for later review, comment, and access.

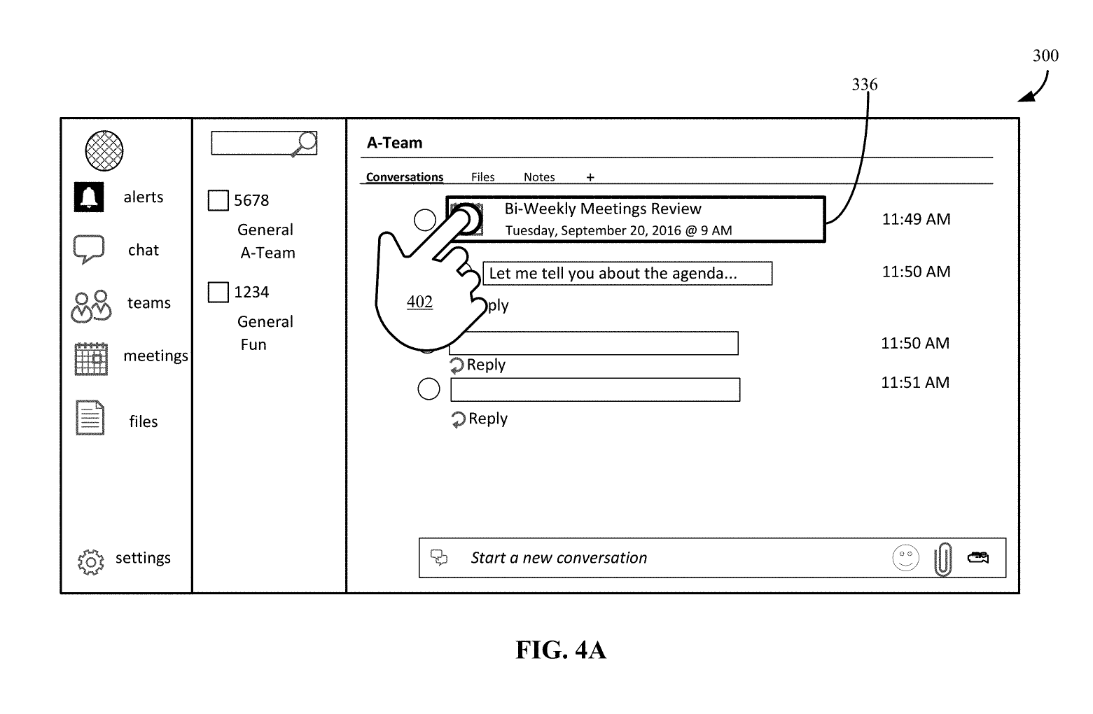

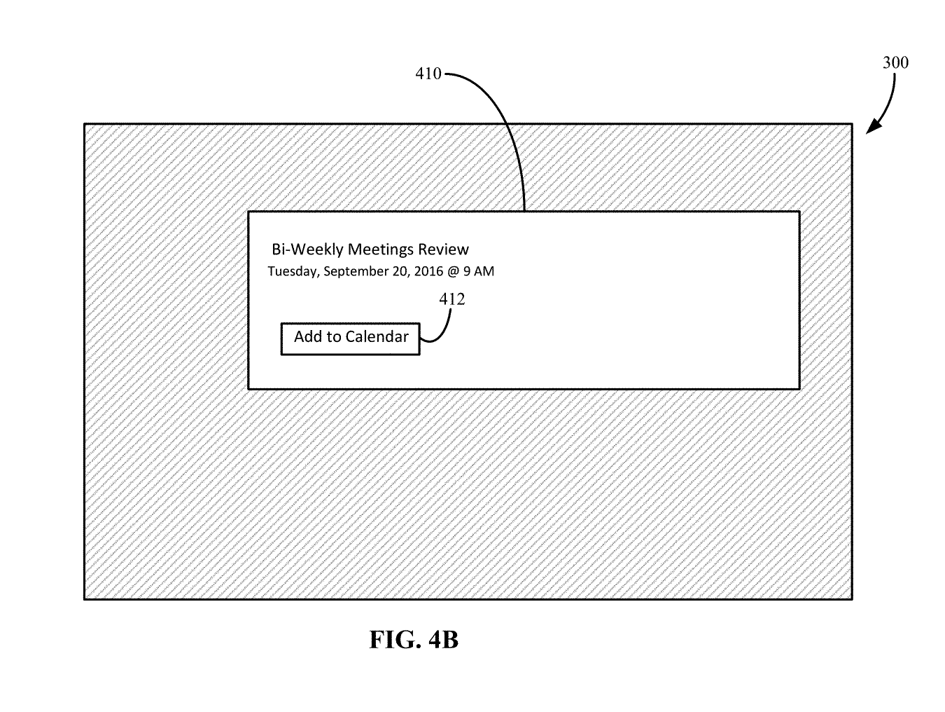

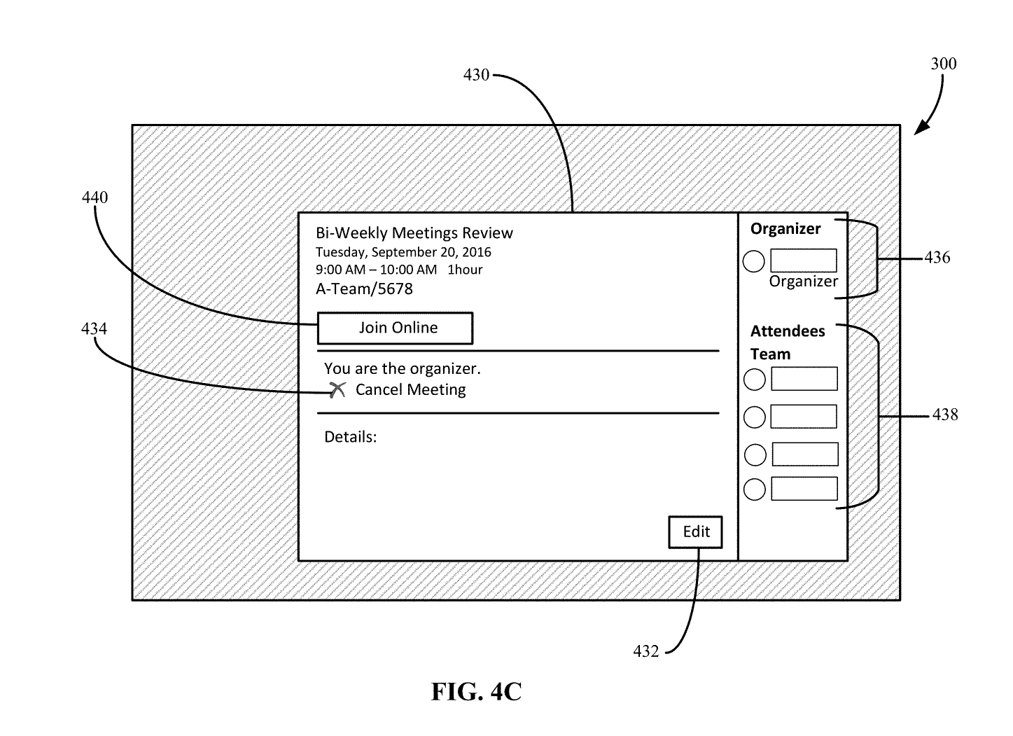

FIGS. 4A-4C illustrate an example scenario in which a team member (who may or may not be the meeting organizer) interacts with the scheduled meeting object 336 displayed in a user interface window 300 at their computing device.

Referring to FIG. 4A, a user may select (402) the scheduled meeting object 336 to view or edit the parameters of the meeting. For example, FIG. 4B shows an interface 410 that may appear in the user interface window 400 upon selecting the scheduled meeting object 336 for a case where the user is not the meeting organizer. As mentioned above, the scheduled meeting object may include one or more parameters such as a start time of the meeting, an end time of the meeting, required attendees of the meeting, details of the meeting, and the like. Some or all of these parameters may be included and may be displayed in a view of the meeting object 336 (and in the interface 410). However, since the user that selected the scheduled meeting object 336 was not the organizer, the parameters are not editable for that user.

In addition, the scheduled meeting object may also include functionality that enables other users to add the object to their calendars. For example, as shown in FIG. 4B, a user may add the meeting as a calendar object to their calendar (e.g., via add to calendar command 412). A user may add the calendar object to a calendar that may be incorporated in the team collaboration tool, or an associated calendar application that may be linked or synced to the team collaboration tool. Adding the calendar object to a calendar creates a scheduled calendar entry of the scheduled meeting object 336 within the calendar. In another implementation, the scheduled calendar entry may automatically be created in a calendar for all users of the collaboration channel upon the creation of the scheduled meeting object 336.

Associated calendars may be accessible to the team collaboration tool (and/or team collaboration service) in several ways. In some cases, the interchange may be accomplished using native API functions of an underlying calendar service within or associated with the calendar application. Some calendars are often accessible through sharing features of the personal information manager service underlying the calendar application. In some cases, a team collaboration tool connects to a larger personal information management service that forms a coordinated storage system for more than one user. Examples of personal information services that may provide interconnectivity functions between users are Microsoft® Exchange, Outlook.com™, and Google® Calendar.

FIG. 4C shows an interface 430 that may appear in the user interface window 400 upon selecting (402) the scheduled meeting object 336 for a case where the user is the meeting organizer. The scheduled meeting item interface 430 may allow the user to view the parameters of the scheduled meeting. If the user is the organizer of the meeting (e.g., the user who requested the creation of the meeting object), the user can edit the parameters of the meeting, for example, by entering an editing mode (not shown) via an edit command 432. In addition, the interface 430 may provide a cancel command 434 so that the user may cancel the meeting.

Both the organizer and the non-organizer user may be able to view organizer information 436, such as a name of the organizer, or a list of invited attendees 438. The list of invited attendees 438 may have been populated by the meeting organizer, auto-populated by the collaboration tool (e.g., based on the context of the users who contributed to a thread that the meeting object is anchored to), and/or updated with users that selected to add the meeting to their calendar. The interface 430 may further include a join command through which users may enter the meeting.

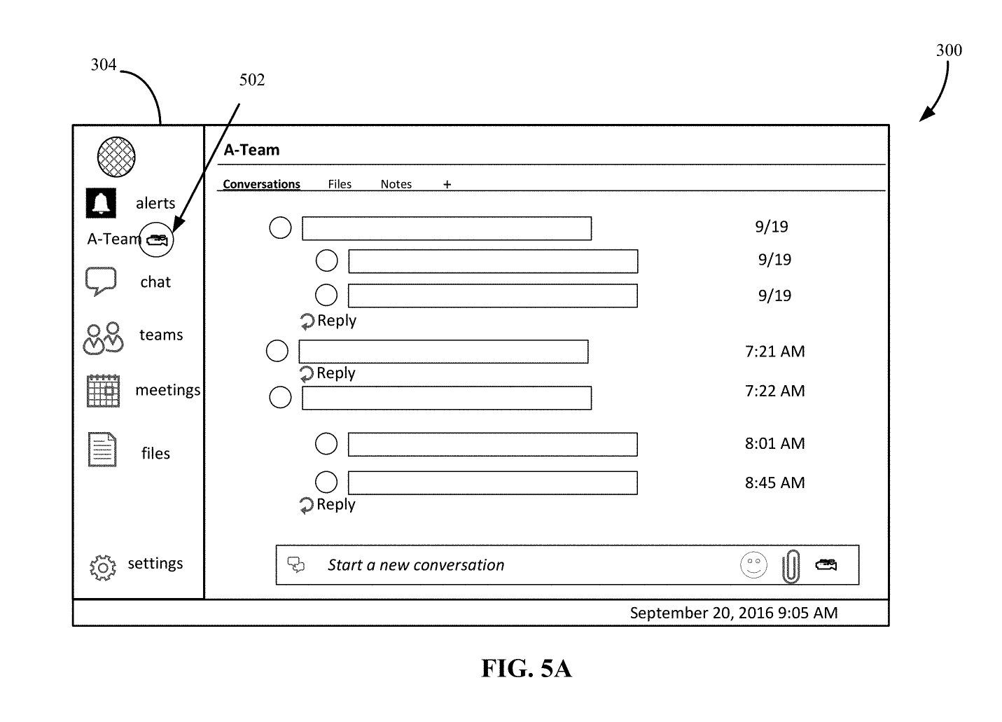

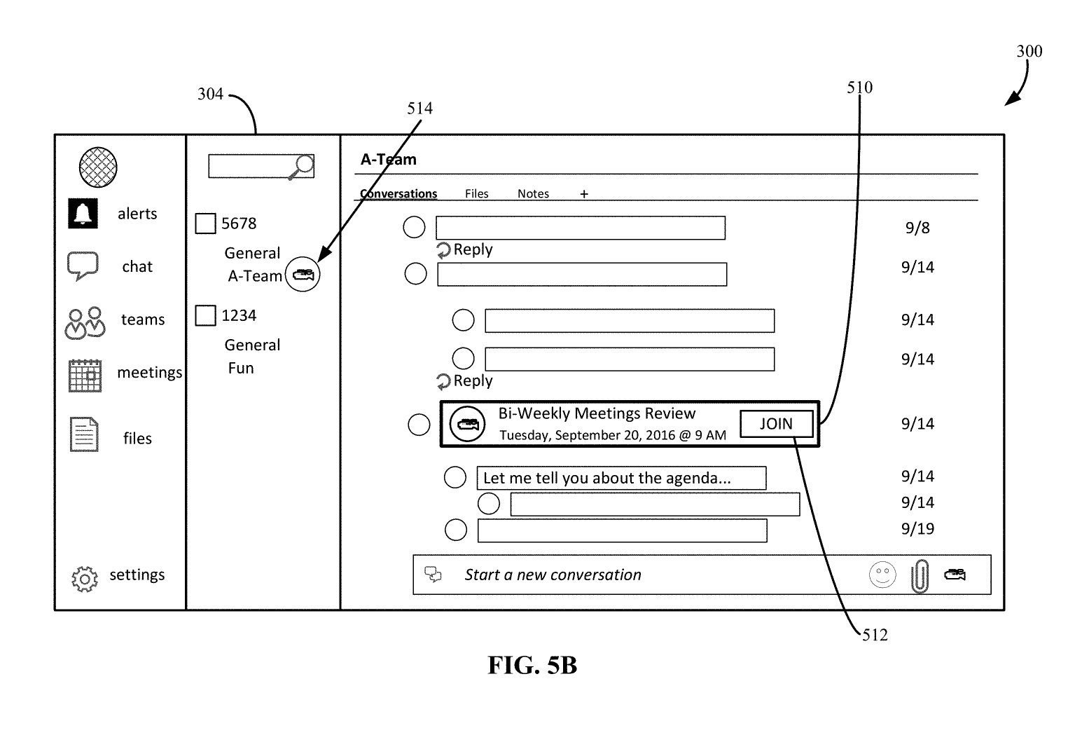

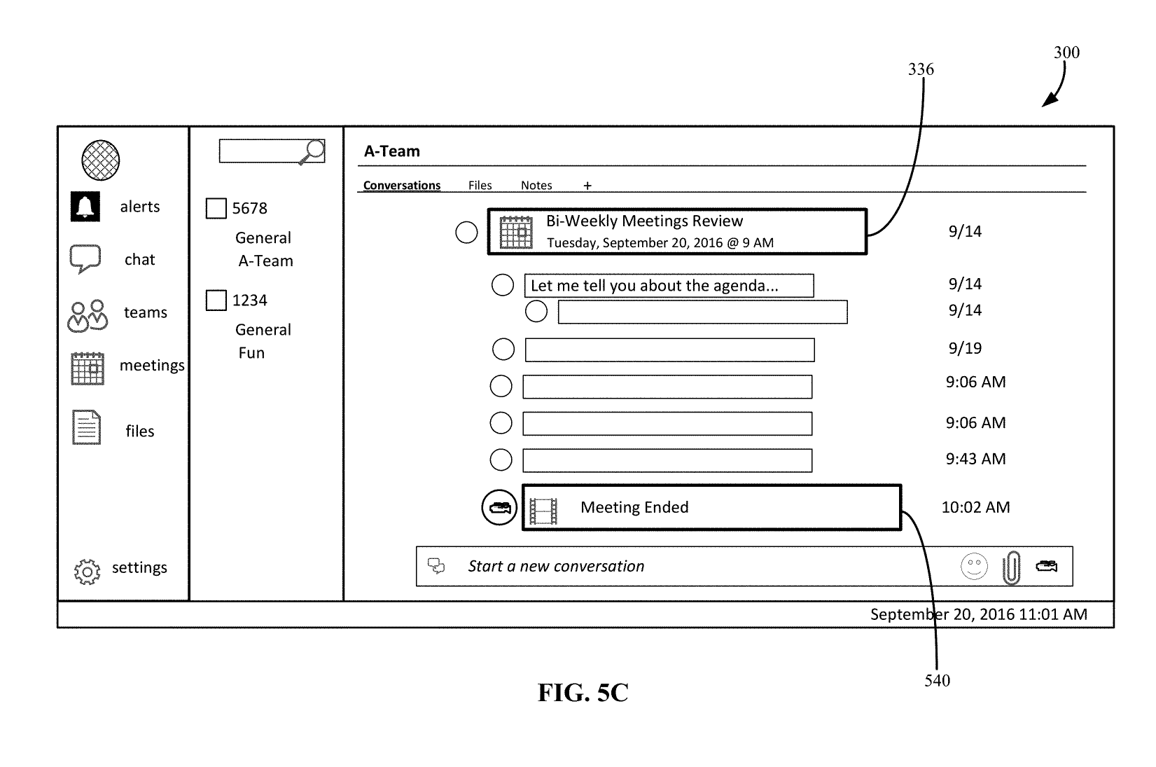

As with a “real-life” meeting involving face-to-face in-person communication, a virtual meeting that is scheduled within a collaboration channel eventually begins (e.g., at a start of a meeting), or can be cancelled before it is scheduled to begin. FIGS. 5A-5C illustrate the progression of a meeting from the start of the meeting to an end of the meeting. A user may use a team collaboration tool to participate in a live meeting within a collaboration channel and can see when their team members are joining together for a meeting so long as they have access to the channel.

Referring to FIGS. 5A and 5B, a user may be notified that meeting is live through a number of mechanisms. In the example in FIG. 5A, the left rail menu 302 of the user interface window 300 can display a meeting started indication 502, indicating that the meeting has started. The meeting started indication 502 can be in the form of an icon or any visual marker that lets the user know that a live meeting is occurring in real time. The user can select the meeting started indication 502 to enter the meeting.

In the example in FIG. 5B, the user can enter a meeting through a live meeting object. FIG. 5B shows an example of a live meeting object 510 displayed in the user interface window 300 of the team collaboration tool. In some cases, the scheduled meeting object (e.g., scheduled meeting object 336) can transform into a live meeting object 510. The live meeting object 510 displays a join command 512. In some cases, the join command 512 can be displayed in conjunction with a meeting started indication 512 in the extended menu 304. A user may enter the meeting through either the meeting started indication 502 in the extended menu 304, the join command 512 displayed on the live meeting object 510, a meeting started indication 502 at the left rail menu 502, or any other indication that may notify the user that a meeting has started. In some cases, a live preview image can be provided via the live meeting object 510 and displayed in the thread.

Upon the user selecting the join command 512, a live instance of the meeting can be displayed in the user interface window 300. For example, if the meeting is conducted by audio/video, an interface may appear that allows the participants of the meeting to view and/or hear each other. In some cases, the live instance of the meeting can be displayed in the extended menu 304.

During the duration of the meeting, any shared content, including messages, are stored (and persist) with the thread. Therefore, any new communication by a user that is created during the meeting, whether the user is participating in the meeting or not, is maintained associated with the live meeting object 510. Because the live meeting object 510 may be derived from the scheduled meeting object 336, the scheduled meeting object 336 may maintain its stored location during the duration of the meeting and at an end of the meeting. At the end of the meeting, the live meeting object 510 may revert to the scheduled meeting object 336. The team collaboration service may also create and display a meeting ended object, as shown in FIG. 5C.

FIG. 5C illustrates an example of the user interface window 300 displaying a meeting ended object 540 that is instantiated at an end of meeting. Upon the conclusion of the meeting, the meeting ended object 540 can be displayed in a thread associated with the scheduled meeting object 336. The meeting ended object 540 can contain data from the meeting. Examples of the data that may be included in a meeting ended object are: any communications that took place during the meeting, including any shared content that was entered into the collaboration channel during the meeting, and any relevant metadata. For example, if the meeting was conducted using audio/video, a user may select the meeting ended object 540 to view a recorded instance of the meeting or to view any shared content that were entered during the meeting. In some cases, the meeting ended object 540 may display a structured summary of the data collected in a thread associated with the scheduled meeting object 336. For example, the meeting ended object 540 may display the attendees of the meeting, the organizer of the meeting, the length of the meeting, any documents attached to the meeting. In another implementation, a user can create another live instance of the meeting by selecting the scheduled meeting object 336 to join a new live instance of the same scheduled meeting that previously ended.

A method for scheduling a live meeting in a channel according to an example can comprise: displaying, at a user device, a collaboration channel in a team collaboration tool; receiving, at the user device, a comment to a thread in the collaboration channel; storing the comment as a first chat object, with a timestamp, associated with the thread; receiving, at the user device, a request for a new meeting within the collaboration channel; in response to receiving the request for the new meeting, creating a scheduled meeting object for a meeting identified by the request for the new meeting; storing the scheduled meeting object as a second chat object, with a second timestamp, associated with the thread; and displaying the comment and the scheduled meeting object within a same thread of the collaboration channel.

Creating the scheduled meeting object can comprise: automatically populating the scheduled meeting object with one or more parameters from a context, the context comprising at least one of a thread identifier for a thread being responded to, other user identifiers associated with chat objects already in the thread, a channel identifier for the channel to which the thread belongs, or a team identifier to which the thread belongs.

Creating the scheduled meeting object can comprise: receiving one or more parameters via input fields of a new meeting item form and populating the scheduled meeting object with the one or more parameters, the one or more parameters comprising at least one of a thread identifier, a channel identifier, or a team identifier.

The method described above can further comprise: at a time of a start of the meeting, transforming the scheduled meeting object at the second timestamp to a live meeting object, wherein the live meeting object comprises a join meeting function for users to join the meeting in progress; and after an end of the meeting, reverting the live meeting object to the scheduled meeting object at the second timestamp.

The method described above can further comprise: after an end of the meeting, creating a meeting ended object and storing the meeting ended object, with a third timestamp, associated with the thread.

The scheduled meeting object can comprise an add to calendar function, wherein the method further comprises: in response to receiving, at the user device, a command to add the meeting to a user calendar, creating a calendar object associated with the scheduled meeting object; and storing the calendar object associated with the user calendar.

FIG. 6 illustrates components of a computing device that may be used in certain implementations described herein; and FIG. 7 illustrates components of a computing system that may be used to implement certain methods and services described herein.

Referring to FIG. 6, system 600 may represent a computing device such as, but not limited to, a personal computer, a tablet computer, a reader, a mobile device, a personal digital assistant, a wearable computer, a smartphone, a laptop computer (notebook or netbook), a gaming device or console, a desktop computer, or a smart television. Accordingly, more or fewer elements described with respect to system 600 may be incorporated to implement a particular computing device.

System 600, for example, includes a processing system 605 of one or more processors to transform or manipulate data according to the instructions of software 610 stored on a storage system 615. Examples of processors of the processing system 605 include general purpose central processing units, application specific processors, and logic devices, as well as any other type of processing device, combinations, or variations thereof.

The software 610 can include an operating system and application programs such as an electronic messaging application, such as team collaboration tool 620 and/or web browsing application, such as browser team collaboration tool 625. In some cases, the software 610 can include a team collaboration service (e.g., team collaboration service 120 of FIG. 1). Device operating systems generally control and coordinate the functions of the various components in the computing device, providing an easier way for applications to connect with lower level interfaces like the networking interface. Non-limiting examples of operating systems include Windows® from Microsoft Corp., Apple® iOS™ from Apple, Inc., Android® OS from Google, Inc., and the Ubuntu variety of the Linux OS from Canonical.

It should be noted that the operating system may be implemented both natively on the computing device and on software virtualization layers running atop the native device operating system (OS). Virtualized OS layers, while not depicted in FIG. 6, can be thought of as additional, nested groupings within the operating system space, each containing an OS, application programs, and APIs.

Storage system 615 can include any computer readable storage media readable by the processing system 605 and capable of storing software 610 including instructions for a team collaboration tool 620 (e.g., team collaboration client 132, 136). Storage system 615 may include volatile and nonvolatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is the storage medium of storage system a transitory propagated signal.

In addition to storage media, in some implementations, storage system 615 may also include communication media over which software may be communicated internally or externally. Storage system 615 may be implemented as a single storage device but may also be implemented across multiple storage devices or sub-systems co-located or distributed relative to each other. Storage system 615 may include additional elements, such as a controller, capable of communicating with processor 605.

Software 610 may be implemented in program instructions and among other functions may, when executed by system 600 in general or processing system 605 in particular, direct system 600 or the one or more processors of processing system 605 to operate as described herein.

The system can further include user interface system 630, which may include input/output (I/O) devices and components that enable communication between a user and the system 600. User interface system 630 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 630 may also include output devices such as display screens, speakers, haptic devices for tactile feedback, and other types of output devices. In certain cases, the input and output devices may be combined in a single device, such as a touchscreen display which both depicts images and receives touch gesture input from the user. Visual output may be depicted on the display in myriad ways, presenting graphical user interface elements, text, images, video, notifications, virtual buttons, virtual keyboards, or any other type of information capable of being depicted in visual form.

The user interface system 630 may also include user interface software and associated software (e.g., for graphics chips and input devices) executed by the OS in support of the various user input and output devices. The associated software assists the OS in communicating user interface hardware events to application programs using defined mechanisms. The user interface system 630 including user interface software may support a graphical user interface, a natural user interface, or any other type of user interface.

Communications interface 640 may include communications connections and devices that allow for communication with other computing systems over one or more communication networks. Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

It should be noted that many elements of system 600 may be included in a system-on-a-chip (SoC) device. These elements may include, but are not limited to, the processing system 605, a communications interface 640, and even elements of the storage system 615.

Certain aspects described herein may be carried out on a system such as shown in FIG. 7. Referring to FIG. 7, system 700 may be implemented within a single computing device or distributed across multiple computing devices or sub-systems that cooperate in executing program instructions. The system 700 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 700 can include a processing system 720, which may include one or more processors and/or other circuitry that retrieves and executes software 705 from storage system 715. Processing system 720 may be implemented within a single processing device but may also be distributed across multiple processing devices or sub-systems that cooperate in executing program instructions.

Examples of processing system 720 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

As with storage system 615 (as shown in FIG. 6), storage system 715 can include any computer readable storage media readable by processing system 720 and capable of storing software 705. Storage system 715 may be implemented as a single storage device but may also be implemented across multiple storage devices or sub-systems co-located or distributed relative to each other. Storage system 715 may include additional elements, such as a controller, capable of communicating with processing system 720.

Software 705 may be implemented in program instructions and among other functions may, when executed by system 700 in general or processing system 720 in particular, direct the system 700 or processing system 720 to operate as described herein for enabling a meeting object. Software 705 may provide program instructions that implement a team collaboration service 710. Service 710 can support a team collaboration tool 735 as well as (or alternatively) provide program instructions for enabling a meeting object.

Software 705 may also include additional processes, programs, or components, such as operating system software or other application software. Software 705 may also include firmware or some other form of machine-readable processing instructions executable by processing system 720.

System 700 may represent any computing system on which software 705 may be staged and from where software 705 may be distributed, transported, downloaded, or otherwise provided to yet another computing system for deployment and execution, or yet additional distribution.

In embodiments where the system 700 includes multiple computing devices, the system can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 725 may be included, providing communication connections and devices that allow for communication between system 700 and other computing systems (not shown) over a communication network or collection of networks (not shown) or the air.

Communication to and from team collaboration clients and the team collaboration service may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

What is claimed is:

1. A computer-implemented method for online meetings in team collaboration tools, the method comprising:
receiving, at a team collaboration server, a request for a scheduled meeting object for a meeting from a team collaboration client of a plurality of team collaboration clients;
determining at least a start time of the meeting and a thread identifier for the scheduled meeting object;
creating the scheduled meeting object with at least the start time; and
storing, at a persistent team collaboration storage, the scheduled meeting object associated with the thread identifier such that the scheduled meeting object is within a thread identified by the thread identifier.

2. The method of claim 1, further comprising:
receiving, at the team collaboration server, a chat object from any of the plurality of the team collaboration clients; and
storing the chat object associated with the thread identifier at the persistent team collaboration storage.

3. The method of claim 2, wherein the chat object is received before the request for the scheduled meeting object, the scheduled meeting object being stored as a subsequent chat object in a threaded history of the thread in the persistent team collaboration storage.

4. The method of claim 2, wherein the chat object is received after the request for the scheduled meeting object, the chat object being stored as a subsequent chat object in a threaded history of the thread in the persistent team collaboration storage.

5. The method of claim 1, further comprising, at the start time of the scheduled meeting object, creating a live meeting object, wherein the live meeting object comprises one or both of a join meeting function and a user identifier of any participant.

6. The method of claim 5, wherein creating the live meeting object comprises:
transforming the scheduled meeting object to the live meeting object.

7. The method of claim 5, further comprising: after the meeting ends, reverting the live meeting object to the scheduled meeting object.

8. The method of claim 1, further comprising:
after the meeting ends, creating a meeting ended object and storing the meeting ended object associated with the thread identifier,
wherein the meeting ended object comprises content shared during the meeting and a user identifier of any participant.

9. The method of claim 1, wherein determining the thread identifier comprises:
identifying from the request, context information for the scheduled meeting object;
determining whether the context includes the thread identifier; and
in response to determining that the context includes the thread identifier, associating the scheduled meeting object with the thread identifier;
in response to determining that the context does not include the thread identifier, generating a new thread identifier as the thread identifier.

10. The method of claim 1, further comprising:
receiving context information with the request for the scheduled meeting object, wherein the context information comprises one or more parameters selected from the group consisting of the thread identifier, a team identifier, a channel identifier, and a user identifier.

11. The method of claim 1, wherein the request for the scheduled meeting object comprises the start time, and one or more parameters selected from the group consisting of an end time, a title, a team, a channel, a description, one or more user identifiers of invitees, and a user identifier of an organizer.

12. One or more computer readable storage media having instructions stored thereon that when executed by a hardware processor, perform a method comprising:
in response to receiving a request for a scheduled meeting object for a meeting, determining at least a start time and a thread identifier for the scheduled meeting object; creating the scheduled meeting object with at least the start time; and storing, at a persistent team collaboration storage, the scheduled meeting object associated with the thread identifier;
at the start time of the scheduled meeting object, creating a live meeting object; and
after the meeting ends, creating a meeting ended object and storing the meeting ended object associated with the thread identifier.

13. The media of claim 12, wherein creating the live meeting object comprises:
transforming the scheduled meeting object to the live meeting object, wherein the live meeting object comprises one or both of a join meeting function and a user identifier of any participant,
the method further comprising:
after the meeting ends, reverting the live meeting object to the scheduled meeting object.

14. The media of claim 12, wherein the meeting ended object comprises content shared during the meeting and a user identifier of any participant.

15. The media of claim 12, wherein the live meeting object comprises one or both of a join meeting function and a user identifier of any participant.

16. The media of claim 12, wherein the scheduled meeting object comprises the start time, and one or more parameters selected from the group consisting of an end time, a title, a team, a channel, a description, one or more user identifiers of invitees, and a user identifier of an organizer.

17. The media of claim 12, further comprising:
receiving, at the team collaboration server, a chat object from any of the plurality of the team collaboration clients; and
storing the chat object associated with the thread identifier at the persistent team collaboration storage.

18. A system comprising:
one or more computer readable storage media;
one or more processors; and
a team collaboration tool embodied in program instructions stored on the one or more computer readable media that, when executed by the one or more processors, direct the one or more processors to:
create a new meeting object, wherein the new meeting object is associated with a thread such that the new meeting object is within the thread.

19. The system of claim 18, wherein the new meeting object comprises a scheduled meeting object, wherein the scheduled meeting object comprises details of a meeting and an address to join the meeting.

20. The system of claim 18, wherein the new meeting object comprises a live meeting object, wherein the live meeting object comprises a join meeting function for users to join the meeting in progress.
